(19) United States
(12) Patent Application Publication
(10) Pub. No.: US 2007/0023514 A1
(43) Pub. Date: Feb. 1, 2007

(54) Method of confidential polling place voting using personal voting codes

(76) Inventor: Fernando Morales, Reston, VA (US)

Correspondence Address: Fernando Morales, 2231 Wakerobin Lane, Reston, VA, 20191, US

(21) Appl. No.: 11/492,821

(22) Filed: Jul. 26, 2006

Related U.S. Application Data
(60) Provisional application No. 60/702,908, filed on Jul. 27, 2005.

(51) Int. Cl. G07C 13/00

(52) U.S. Cl. 235/386; 705/12; 235/51

(57) ABSTRACT

A method to improve precinct privacy can be achieved after a successful voter verification process, by using the computerized list (as defined by HAVA), if we extract the voter's voting code and then secretly and securely load it into the device (smart card) required by the voting equipment to guarantee that the voter can cast his/her vote only once. Once the voting equipment gets the voting code, the voter can type sequential numbers to fill-out the available alternatives for each question on the ballot; for example, Mr. Bush, 3; Mr. Edwards, 4; Mr. Buchanan, 5 . . . and so on. Hence only the voter and the voting equipment would know what the voter's selections were even if a camera or recording device was used. If a paper verification printer is required, the printer output, even though visible, would not disclose the voting code. It would still hold all the required information for a paper recount. This is easily achieved by encrypting (with an election-official key) the voter's voting code before printing.

### CROSS-REFERENCE TO RELATED APPLICATION

This application claims priority under 35 U.S.C. §119(e) of U.S. Provisional Patent Application No. 60/702,908, filed on Jul. 27, 2005, the disclosure of which is hereby incorporated by reference thereto in its entirety.

### BACKGROUND OF THE INVENTION

1. Field of the Invention

The invention is directed to a method of confidential voting, particularly for voting using an electronic machine to completed ballot, while maintaining confidentiality, even in the presence of third parties while the ballot is completed.

More particularly, the invention is directed to a method of casting a vote at the polling places.

2. Description of Background and Relevant Information

After more than a hundred years since the last revision of the Federal electoral law, the U.S. Congress passed The Help America Vote Act of 2002 (HAVA). The U.S. Election Assistance Commission (EAC) was established by HAVA. Central to its role, the Commission serves as a national clearinghouse and resource for information and review of procedures with respect to the administration of federal elections. According to the text of HAVA, the law was enacted to:
. . . establish a program to provide funds to states to replace punch card voting systems, to establish the Election Assistance Commission to assist in the administration of federal elections and to otherwise provide assistance with the administration of certain federal election laws and programs, to establish minimum election administration standards for states and units of local government with responsibility for the administration of federal elections, and for other purposes.
Excerpt from The Help America Vote Act of 2002

The Help America Vote Act of 2002 (HAVA) requires the Election Assistance Commission (EAC) among other things to generate technical guidance on the administration of federal elections and produce voluntary voting systems guidelines.

The Guidelines were developed by the HAVA-designated Technical Guidelines Development Committee (TGDC), comprised of technical experts, disability experts and election officials, and the National Institute of Standards and Technology (NIST).

The 2002 Help America Vote Act has given NIST a key role in helping to realize nationwide improvements in voting systems by January 2006. To assist the Election Assistance Commission with the development of voluntary voting system guidelines, HAVA established the TGDC and directs NIST to chair the TGDC. NIST research activities include:
security of computers, computer networks, and computer data storage used in voting systems;
methods to detect and prevent fraud;
protection of voter privacy; and
the role of human factors in the design and application of voting systems, including assistive technologies for individuals with disabilities (including blindness) and varying levels of literacy.

On May 9, 2005, the Technical Guidelines Development Committee (TGDC) delivered an initial set of recommendations for new voluntary voting system guidelines (known as the May 9, 2005 Voluntary Voting System Guidelines (VVSG) Version 1, Initial Report) to the Election Assistance Commission (EAC). After the EAC was reviewing these recommendations they made a determination as to what they will put forward as the EAC's proposed voting system guidelines for public comment, on Jul. 31, 2005, the inventor of the invention disclosed herein submitted a comment claiming that the VVSG Volume 1, Pg 242; lines 13 and 14 are non-compliant with HAVA requirements of privacy. The comments describes the means that are disclosed herein.

The EAC's proposed guidelines were posted in the Federal Register and the EAC made the proposed guidelines document available for download from their website.

EAC accepted comments on the Guidelines for 90 days. Comments were posted on the website, submitted via email to votingsystemguidelines@eac.aov or mailed to: Voting System Guidelines Comments, U.S. Election Assistance Commission, 1225 New York Avenue, N.W., Suite 1100, Washington, DC 20005. The Guidelines were also available in hard copy and CD-ROM formats. Copies could be obtained by contacting EAC at 1-866-747-1471 or by visiting the EAC website at www.eac.gov.

At the conclusion of the public comment period and after the consideration of comments received, on Dec. 13, 2005, the EAC unanimously adopted the 2005 Voluntary Voting System Guidelines (VVSG 2005), which they claim then will significantly increase security requirements for voting systems and expand access, including opportunities to vote privately and independently, for individuals with disabilities. On Jan. 13, 2006, the EAC posted the VVSG 2005 as follows:
The VVSG 2005 defines privacy as the ability to prevent others from determining how an individual voted. (See page A-14 of the VVSG 2005).
3.1.7 Privacy
The voting process shall preclude anyone else from determining the content of a voter's ballot, without the voter's cooperation.
Discussion: Privacy ensures that the voter can make selections based solely on his her own preferences without intimidation or inhibition. Among other practices, this forbids the issuance of a receipt to the voter that would provide proof on how he or she voted. (See page 51 of the VVSG 2005).
The guidelines will take effect in December 2007 (24 months), at which time voting systems will no longer be tested against the 2002 Voting System Standards (VSS) developed by the Federal Election Commission. All previous versions of national standards will become obsolete at that time.
The voluntary guidelines provide a set of specifications and requirements against which voting systems can be tested to determine if the systems provide all of the basic functionality, accessibility and security capabilities required of these systems. In addition, the guidelines establish evaluation criteria for the national certification of voting systems.
The guidelines update and augment the 2002 VSS, as required by HAVA, to address advancements in election practices and computer technologies. These guidelines are voluntary. States may decide to adopt them entirely or in part prior to the effective date. Currently, at least 39 states use the national guidelines in their voting system certification process.

During the 90-day public comment period, EAC received more than 6,000 comments on the proposed guidelines. Each comment was reviewed and considered by EAC in consultation with the National Institute of Standards and Technology (NIST) in the development of the final version (VVSG 2005).

HAVA Section 301 Voting Systems Standards are a Federal mandate to all the States on and after Jan. 1, 2006. HAVA Section 301(c)(2) includes a dynamic mandate designed to reach the state of the art, or level of excellence on protection of paper ballot voting systems.

For that reason at the time the EAC adopted the VVSG (Dec. 13, 2005) the privacy on all voting systems was raised to a new minimum, consistent with the invention disclosed and claimed herein.

The record shows as indisputable fact that the TGDC was unable to discover a solution to protect privacy at the polling places, when the voter has a camera or an audio recording device. This fact clearly demonstrates that the solution described herein was not known nor obvious to experts, who were quite aware of U.S. Pat. No. 6,607,137 as early as the day they were appointed to serve on the TGDC by the EAC, and as the NIST record shows precisely from the inventor's communication to them, which can be found at the NIST website: www.vote.nist.gov/ECPosStat.htm

A review of numerous patents and published patent applications shows that only U.S. Pat. No. 6,607,137, the inventor of which is the inventor of the current subject matter, discloses how to achieve privacy when voting occurs with observers, but in no way explains how to achieve the same level of privacy protection using electronic machines to vote inside a booth at the polling places. Thus this innovative concept to use personal voting codes described in U.S. Pat. No. 6,607,137, using the invention described herein, can be used at the polling places with or without a booth. The disclosure of U.S. Pat. No. 6,607,137 is hereby incorporated by reference thereto in its entirety and particularly with reference to the aforementioned personal voting codes.

Elections are the backbone of democracy, privacy ensures that the powerful cannot control the outcome of an election, which in many past cases was won by a few votes. There is a need for voting privacy to ensure that the voter can make selections based solely on his/her own preferences without intimidation, inhibition or economic incentives.

It is an object of the invention therefore to provide a method to vote with privacy for people with motion disabilities.

It is an object of the invention therefore to provide the convenience to vote carrying a cellular phone, to all voters that are required by Federal law to vote at the polling place without carrying a cellular phone, because it was the only way to prevent vote treading, coercion or intimidation.

These and other advantages of the invention will become more fully apparent when the following detailed description of the invention is read in conjunction with the accompanying drawings.

### BRIEF DESCRIPTION OF THE DRAWINGS

Other aspects of the invention will be set forth in the following detailed description, which refers to the appended drawings in which:

FIG. 1 is a schematic illustration of a polling place system of the invention; and

FIG. 2 is another schematic illustration of a polling place system of the invention.

### DETAILED DESCRIPTION OF THE INVENTION

The invention is directed to a method for ensuring privacy at the polling places for non-paper ballot voting systems, or systems using non-electronic ballots. The invention is also directed to the system itself. By means of the invention, the voter can make selections based solely on his/her own preferences without intimidation, inhibition or economic incentive. Furthermore, the system prevents election officials and observers of the electoral tally from determining how any individual voted.

Turning now to the drawing figures, the overall configuration of the invention and its components are described below.

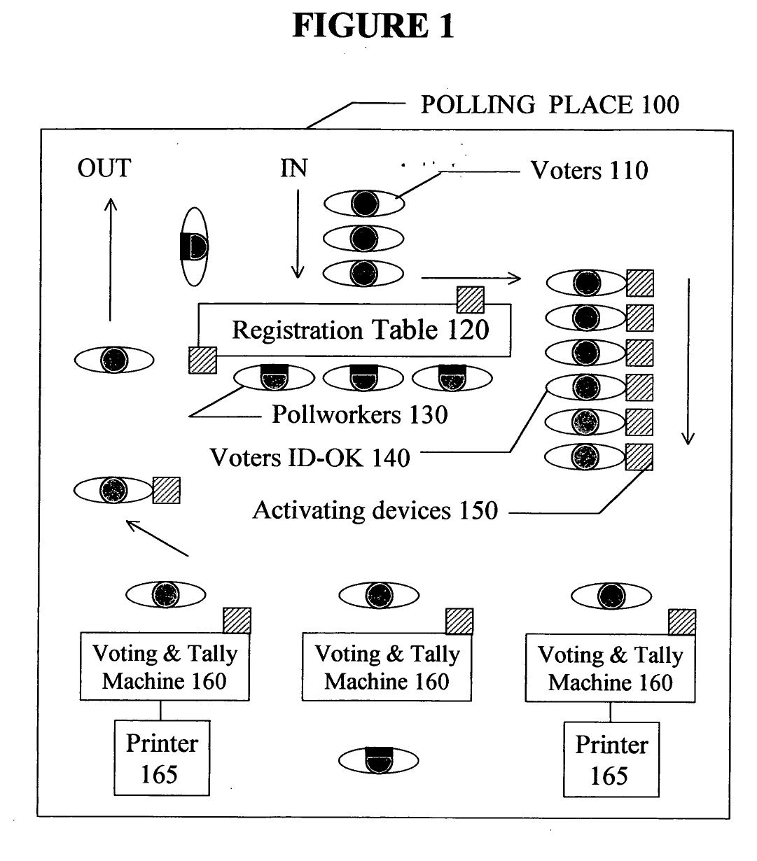

FIG. 1 essentially shows a polling place 100 with a flow of voters 110 which stop for ID verification at he registration table 120, Pollworkers 130 after determined that the voter 110 is ok to vote hand delivery to the voter an activating device 150 after they load the voter's PVC on it. Voters 110 wait in line for an available voting machine 160, and then insert on the machine the activating device 150 which allow the voting machine 150 to cast only one vote per voter and at the same time reveal the voter's PVC to the machine 160 to tally accordantly. Printer 165 print the cast ballot for voter verification as well as an encrypted PVC that can be use for manual recounts. Voters shall return the activating devices 150 to the Pollworkers 130 sited at the registration table 120 before they leave the polling place 100.

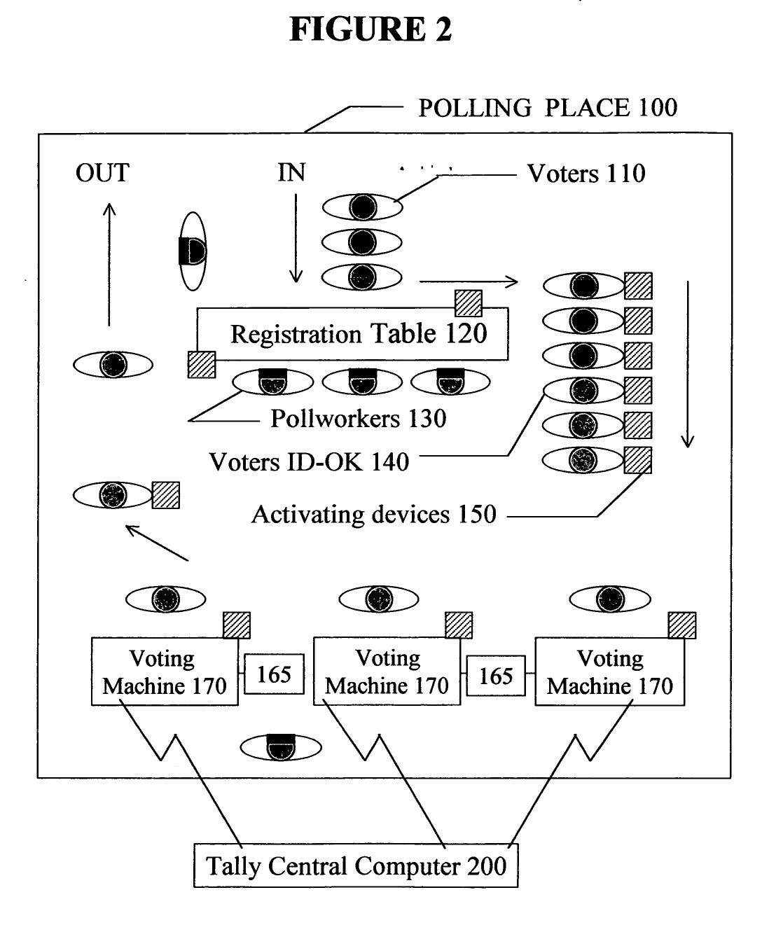

In a particular embodiment of the invention, a tally central computer shown in FIG. 2 communicates with the voting machines 170 located inside the polling places 100 to archive a centralize tally, the polling place flow of voters 110 can be identical as the description on FIG. 1.

After election day verification can be achieved by publishing all ballots associated with a random number generated by the voting machine at the time that the voter was present and inform them that that number can be use for that purpose.

Those skilled in the art of the present invention will recognize that other embodiments using the concepts described herein are also possible, to protect the secrecy of the vote without voter's cooperation, such alternatives and equivalents being encompassed within the claimed invention.

1. A voting method using a voter's personal voting code enabled device for confidential identification of one or more ballot choices on a tally machine, said method comprising:
using the voter's personal voting code to communicate one or more choices of the voter to the tally machine.

2. A voting method according to claim 1, further comprising:
placing the voting code enabled device, after the elections officials load on it the voter's personal voting code, into a tally machine.

3. A voting method according to claim 2, wherein the voting code enabled device further comprising:
determining, by an election official or designated precinct worker, the voter's personal voting code maintained in an electoral list;
entering, by the election official or designated precinct worker, the voter's personal voting code on the voting code enabled device.

4. A voting method according to claim 2, wherein the voting code enabled device is use to allow the voter to cast a vote only once for each question presented by the tally machine.

5. A voting method using a voter's personal voting code enabled device for confidential identification of one or more ballot choices on a machine remotely connected with a central tally machine, said method comprising:
using the voter's personal voting code to communicate one or more choices of the voter to the tally machine.
